(19) United States
(12) Patent Application Publication
(10) Pub. No.: US 2017/0272828 A1
(43) Pub. Date: Sep. 21, 2017

(54) IMAGE DISPLAY APPARATUS AND METHOD OF OPERATING THE SAME

(71) Applicant: SAMSUNG ELECTRONICS CO., LTD., Suwon-si (KR)

(72) Inventors: Soo-hyang KIM, Suwon-si (KR); Mun-seok KIM, Hwaseong-si (KR)

(73) Assignee: SAMSUNG ELECTRONICS CO., LTD., Suwon-si (KR)

(21) Appl. No.: 15/450,701

(22) Filed: Mar. 6, 2017

Related U.S. Application Data
(60) Provisional application No. 62/309,593, filed on Mar. 17, 2016.

(30) Foreign Application Priority Data
Oct. 28, 2016 (KR) 10-2016-0142154

(51) Int. Cl. H04N 21/482; H04N 21/462; H04N 21/485; H04N 21/84

(52) U.S. Cl. CPC H04N 21/4828; H04N 21/84; H04N 21/4622; H04N 21/485

(57) ABSTRACT

An image display apparatus and a method of operating the same are provided. The image display apparatus includes a display; a broadcast signal receiver configured to receive a broadcast signal; a processor; and a memory that stores instructions for providing a service based on the broadcast signal received via the broadcast signal receiver, reading service linkage information related to the service from the broadcast signal, determining whether to provide a target service connected to the service based on the service linkage information and information regarding a specification of the image display apparatus, and displaying an object related to execution of the target service on the display based on availability of the target service.

### CROSS-REFERENCE TO RELATED APPLICATIONS

This application claims the benefit of U.S. Provisional Application No. 62/309,593, filed on Mar. 17, 2016 in the US Patent Office, and claims priority from Korean Patent Application No. 10-2016-0142154, filed on Oct. 28, 2016 in the Korean Intellectual Property Office, the disclosures of which are incorporated herein by reference in their entireties.

### BACKGROUND

1. Field

Apparatuses and methods consistent with exemplary embodiments relate to an image display apparatus and a method of operating the same, and more particularly, to an image display apparatus capable of providing a target service connected to a current service and a method of operating the same.

2. Description of the Related Art

An image display apparatus displays an image that a user can view. An image display apparatus may display a broadcast selected by a user from among broadcast signals transmitted from a broadcast station.

Also, smart televisions (TVs) provide various contents in addition having to a broadcast receiving function. A benefit of a smart TV is that it is not necessary to operate manually according to a user's selection, but rather, the smart TV may analyze and provide what a user demands without a user's manipulation.

The Advanced Television Systems Committee (ATSC) 1.0 standard is a digital broadcasting standard which includes no specification for defining information regarding other services associated with a current service. Therefore, when a current program is extended, a broadcasting station may continuously transmit the current program or interrupt the current program and transmit a next program. In this case, because the program is arbitrarily selected and transmitted by the broadcasting station without a user's choice, there is a problem in that the user does not have a choice of what program to watch.

### SUMMARY

Exemplary embodiments provide an image display apparatus that determines whether a target service connected to a current service may be provided and, when the target service may be provided, the image display apparatus provides a user interface for selecting the target service, and a method of operating the image display apparatus.

Additional aspects will be set forth in part in the description which follows and, in part, will be apparent from the description, or may be learned by practice of exemplary embodiments.

According to an aspect of an exemplary embodiment, there is provided an image display apparatus including: a display; a receiver configured to receive a broadcast signal; a processor; and a memory configured to store instructions that, when executed, cause the processor to: provide a service based on the received broadcast signal; process service linkage information related to the service based on the received broadcast signal; determine whether to provide a target service connected to the service based on specification information of the image display apparatus and the service linkage information; and display an object related to an execution of the target service on the display based on an availability of the target service.

The service linkage information may include at least one from among broadcast service ID (BSID) information regarding the target service, identification information regarding the target service, information regarding a route for providing the target service, and information regarding a capability of a receiver for providing the target service.

The instructions may cause the processor to determine whether a channel corresponding to the target service exists in a channel database of the image display apparatus based on the BSID information regarding the target service and the identification information regarding the target service and, in response to determining that a channel corresponding to the target service exists in the channel database, display an object related to the execution of the target service on the display.

The instructions may cause the processor to, in response to determining that a channel corresponding to the target service does not exist in the channel database, search for a channel corresponding to the target service.

The instructions may cause the processor to, in response to determining that a channel corresponding to the target service is not found, not display an object related to the execution of the target service.

The instructions may cause the processor to determine whether the target service is to be provided via a broadcast network or an Internet network based on the information regarding the route for providing the target service and, in response to determining that the target service is to be provided via the Internet network and the image display apparatus is connected to the Internet network, display an object related to the execution of the target service.

The instructions may cause the processor to determine whether the target service is to be provided via a broadcast network or an Internet network based on the information regarding the route for providing the target service and, in response to determining that the target service is to be provided via the Internet network and the image display apparatus is not connected to the Internet network, display a guide message instructing to connect the image display apparatus to the Internet network.

The instructions may cause the processor to, in response to determining that the specification of the image display apparatus satisfies the capability of the receiver for reproducing content of the target service, display an object related to the execution of the target service.

The instructions may cause the processor to, in response to determining that the specification of the image display apparatus does not satisfy the capability of the receiver for reproducing content of the target service, not display an object related to the execution of the target service.

An object indicating the target service may include a connection icon indicating a switch to the target service, and the instructions cause the processor to, in response to determining that an input for selecting the connection icon is received, switch a current service to the target service.

The instructions may cause the processor to receive a service layer signaling (SLS) regarding a current service and obtain the service linkage information from the SLS.

The instructions may cause the processor to obtain the service linkage information from a user service bundle description (USBD) fragment included in the SLS.

According to an aspect of another exemplary embodiment, there is provided a method of operating an image display apparatus, the method including: receiving a broadcast signal; processing service linkage information related to a service provided based on the received broadcast signal; determining whether to provide a target service connected to the service based on specification information of the image display apparatus and the service linkage information; and displaying an object related to an execution of the target service based on an availability of the target service.

The service linkage information may include at least one from among broadcast service ID (BSID) information regarding the target service, identification information regarding the target service, information regarding a route for providing the target service, and information regarding a capability of a receiver for providing the target service.

The determining whether to provide the target service may include determining whether a channel corresponding to the target service exists in a channel database of the image display apparatus based on the BSID information regarding the target service and the identification information regarding the target service, and wherein the displaying the object related to the execution of the target service may include, in response to determining that a channel corresponding to the target service exists in the channel database, displaying an object related to the execution of the target service.

The method may include searching for a channel corresponding to the target service in response to determining that a channel corresponding to the target service does not exist in the channel database, wherein the displaying of the object related to the execution of the target service may include, in response to determining that a channel corresponding to the target service is found, displaying an object related to the execution of the target service.

The determining whether to provide the target service may include determining whether the target service is to be provided via a broadcast network or an Internet network based on the information regarding the route for providing the target service, and wherein the displaying the object related to the execution of the target service may include, in response to determining that the target service is to be provided via the Internet network and the image display apparatus is connected to the Internet network, displaying an object related to the execution of the target service.

The determining whether to provide the target service may include determining whether the target service is to be provided via a broadcast network or an Internet network based on the information regarding the route for providing the target service, and wherein the displaying the object related to the execution of the target service may include, in response to determining that the target service is to be provided via the Internet network and the image display apparatus is not connected to the Internet network, displaying a guide message instructing to connect the image display apparatus to the Internet network.

The determining whether to provide the target service may include determining whether the specification of the image display apparatus satisfies the capability of the receiver for reproducing content of the target service, and wherein the displaying of the object related to execution of the target service may include displaying an object related to execution of the target service in response to determining that the specification of the image display apparatus satisfies the capability of the receiver for reproducing content of the target service.

According to an aspect of another exemplary embodiment, there is provided a non-transitory computer readable recording medium having recorded thereon a computer program for executing a method.

According to an aspect of another exemplary embodiment, there is provided an image display apparatus including: a receiver configured to receive a broadcast signal; a memory; and a processor configured to store instructions that, when executed, cause the processor to: display a first program channel based on the received broadcast signal; and based on specification information of the image display apparatus and service linkage information provided in the broadcast signal, determine whether to switch the first program channel to a second program channel.

The image display apparatus may include a sensor configured to sense a user input of at least one from among a user's voice, a user's image, and a user's interaction, wherein the instructions may cause the processor to, in response to receiving the user input, switch to the second program channel.

The instructions may cause the processor to receive a service layer signaling (SLS) regarding a current program channel and obtain the service linkage information from the SLS.

The instructions may cause the processor to, in response to determining that the second program channel does not exist in the channel database, search for a third program channel.

### BRIEF DESCRIPTION OF THE DRAWINGS

The above and/or other aspects will become apparent and more readily appreciated from the following description of exemplary embodiments, taken in conjunction with the accompanying drawings in which:

FIG. 1 is a diagram showing a method by which an image display apparatus provides a connected service, according to an exemplary embodiment;

FIG. 2 is a block diagram showing a configuration of an image display apparatus according to an exemplary embodiment;

FIG. 3 is a block diagram showing a configuration of an image display apparatus according to another exemplary embodiment;

FIGS. 4 through 7 are flowcharts of methods by which an image display apparatus provides a target service, according to one or more exemplary embodiments;

FIGS. 8 and 9 are diagrams illustrating a method by which an image display apparatus provides a target service, according to an exemplary embodiment; and

FIG. 10 is a diagram illustrating a method by which an image display apparatus displays a guide message, according to an exemplary embodiment;

FIG. 11 is a diagram illustrating a method by which an image display apparatus displays a guide message for service connection, according to an exemplary embodiment.

### DETAILED DESCRIPTION

Reference will now be made in detail to exemplary embodiments, examples of which are illustrated in the accompanying drawings, in which like reference numerals refer to like elements throughout. In this regard, exemplary embodiments may have different forms and should not be construed as being limited to the descriptions set forth herein. Exemplary embodiments are described below, by referring to the figures, to explain aspects. Expressions such as “at least one of,” when preceding a list of elements, modify the entire list of elements and do not modify the individual elements of the list.

The terms used in this specification will be briefly described, and then exemplary embodiments will be described in detail.

With respect to the terms for describing exemplary embodiments, general terms which are widely used are selected in consideration of functions of structural elements in the exemplary embodiments. However, meanings of the terms may be changed according to intention, a judicial precedent, appearance of a new technology, and the like. In addition, in some cases, a term which is not commonly used may be selected. In this case, the meaning of the term will be described in detail at the corresponding part in the description. Therefore, the terms used in describing exemplary embodiments should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

Below, exemplary embodiments will be described in detail with reference to the accompanying drawings. Exemplary embodiments may, however, be embodied in many different forms and should not be construed as limited to the embodiments set forth herein. In order to clearly illustrate exemplary embodiments in the drawings, parts not related to the description may be omitted, and like elements are denoted by like reference numerals throughout the specification.

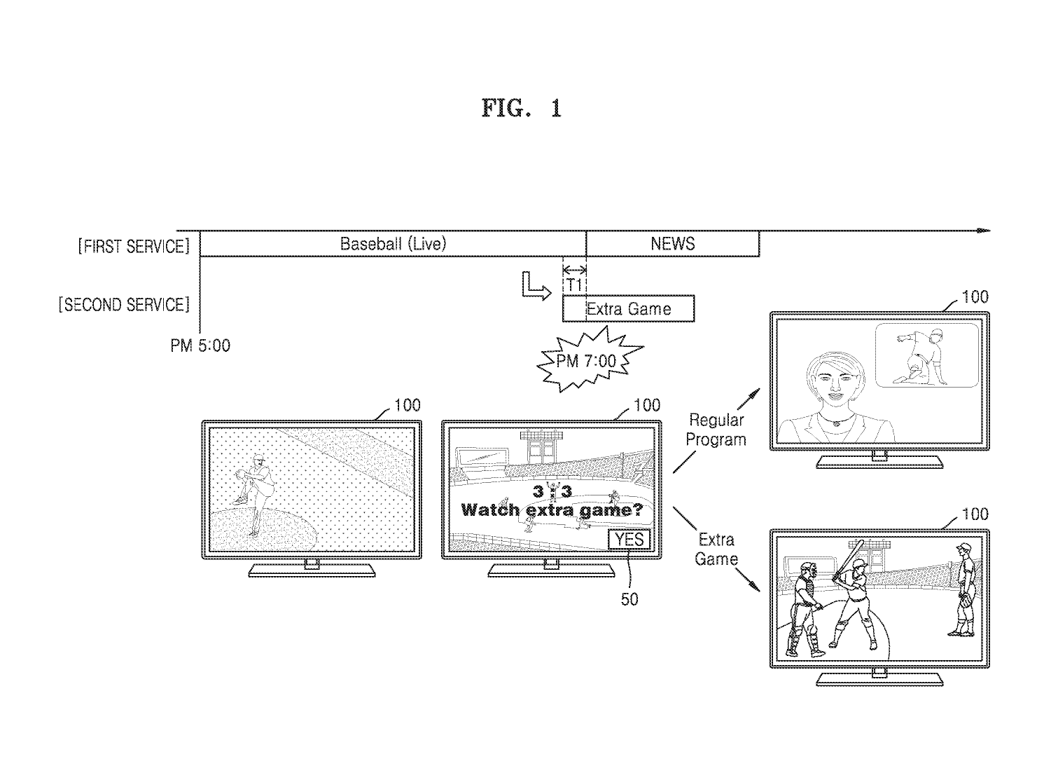

FIG. 1 is a diagram showing a method in which an image display apparatus provides a connected service, according to an exemplary embodiment.

As shown in FIG. 1, an image display apparatus 100 may be a television (TV), but this is merely an example, and it may be embodied as any electronic apparatus capable of receiving a broadcast signal and displaying an image based on the broadcast signal. For example, the image display apparatus 100 may be a mobile phone, a tablet personal computer (PC), a digital camera, a camcorder, a laptop computer, a desktop PC, an e-book terminal, a digital broadcast terminal, a personal digital assistant (PDA), a portable multimedia players (PMP), a navigation device, an MP3 player, a wearable device, etc.

The image display apparatus 100 may be a stationary type or a mobile type and may be a digital broadcasting receiver capable of receiving digital broadcasts. Furthermore, the image display apparatus 100 may be embodied as a flat-panel display apparatus, a curved display apparatus having a display screen with a curvature, and/or a flexible display apparatus capable of adjusting a curvature of a display screen. The output resolution of the image display apparatus 100 may include, for example, standard definition, high definition (HD), full HD, ultra HD, and/or a resolution that is clearer than ultra HD.

The term “user,” according to an exemplary embodiment, refers to a person who controls the function or operation of the image display apparatus 100 by using a control device and may include a viewer, an administrator, and/or an installation technician.

A service provided by the image display apparatus 100, according to an exemplary embodiment, may include at least one component. A service is a collection of media components that are provided to a user, and the components may be media in various formats (e.g., television program channels, movie files, audio files, internet files). One service may be provided continuously or intermittently and may be provided in real-time or non-real-time. An example of real-time service may include a series of TV programs (e.g., program channels). A service may include information from the Internet. Furthermore, the service according to an exemplary embodiment may include a broadcast service, and the broadcast service may include at least one content component.

For example, referring to FIG. 1, the image display apparatus 100 may provide a first service that includes a first content component and a second content component. Here, the first content component may correspond to a baseball broadcast program, whereas the second content component may correspond to a news broadcast program.

The image display apparatus 100 may receive service linkage information regarding the first service. For example, the image display apparatus 100 may receive a broadcast signal and read service linkage information related to a certain service provided based on the broadcast signal, from the received broadcast signal.

The service linkage information may include information regarding a connected service (target service) connected to the first service (e.g., the information may include a broadcast service identifier (BSID) of the target service and a target service identifier (ID)), information regarding a time period during which the target service is available (e.g., the information may include an activated time and an inactivated time), information regarding a link type, information regarding a route for providing a target service (e.g., information indicating whether the target service is provided via a broadcast network or an Internet network), and information regarding capability of a receiver that is demanded for reproducing the target service. However, exemplary embodiments are not limited thereto.

The image display apparatus 100 may receive a service level signaling (SLS) and obtain service linkage information from the SLS. For example, the image display apparatus 100 may obtain service linkage information based on a service linkage element in a user service bundle description (USBD) fragment included in the SLS.

As shown in FIG. 1, even when a baseball game being broadcast in the first service is extended, the baseball broadcast program is terminated according to a broadcast schedule of the first service. At this time, the broadcasting station may provide an extended baseball broadcasting program in a second service different from the first service. For example, when it is scheduled for the first service to provide the baseball broadcast program from 5:00 pm to 7:00 pm and to provide a news broadcast program from 7:00 pm to 8:00 pm, a baseball broadcast after 7:00 pm may be provided in the second service different from the first service.

In this case, the image display apparatus 100 according to an exemplary embodiment may receive service linkage information regarding the first service. At this time, the service linkage information regarding the first service may include information regarding a second service connected to the first service (e.g., information regarding the BSID for providing the second service and identification information regarding the second service), information regarding a time period during which the second service is available (including an activated time and an inactivated time), information regarding a link type, information regarding a route for providing the second service, information regarding a necessary capability of a receiver for reproducing content of the second service, etc.

The image display apparatus 100 may display a user interface (UI) screen image including an object 50 for switching to the second service in a screen image provided by the first service during a first time period T1 during which the second service is available. If the image display apparatus 100 receives an input to switch to the second service, the image display apparatus 100 may switch the first service to the second service and provide the baseball broadcasting extended in the second service.

If no input to switch to the second service is received and the time period during which the second service is available expires, the image display apparatus 100 may terminate displaying of the UI screen image for switching to the second service. Furthermore, the image display apparatus 100 may provide a news broadcast according to the broadcast schedule of the first service.

Even if an input to switch to the second service is received, the second service may not be provided unless the specification of the image display apparatus conforms to the specification of the second service (e.g., target service). In this case, the first service may not be switched to the second service, thereby causing confusion to a user of the image display apparatus 100.

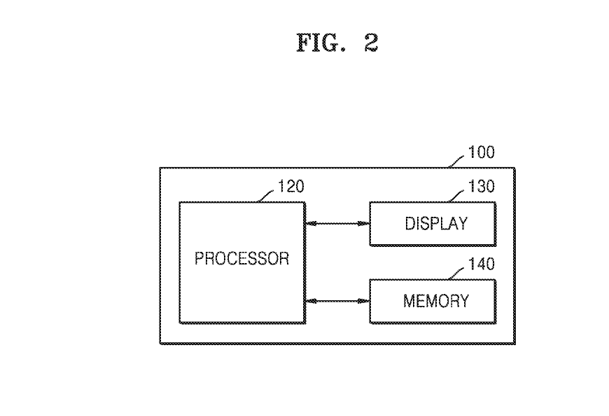

FIG. 2 is a block diagram showing a configuration of an image display apparatus according to an exemplary embodiment.

Referring to FIG. 2, the image display apparatus 100 according to an exemplary embodiment may include a processor 120, a display 130, and a memory 140.

The display 130 according to an exemplary embodiment converts a video signal, a data signal, an on-screen-display (OSD) signal, a control signal, and the like, processed by the processor 120 and generates a driving signal. The display 130 may be implemented as a plasma display panel (PDP), a liquid crystal display (LCD), an organic light-emitting diode (OLED), a flexible display, or a 3D display. Furthermore, the display 130 may be configured as a touch screen and used not only as an output device, but also as an input device.

The display 130 according to an exemplary embodiment may display content provided by a current service. Furthermore, when a target service connected to the current service may be provided by the image display apparatus 100, the display 130 may display an object indicating the target service. The object indicating the target service may include an object related to execution of the target service. For example, the display 130 may display an icon or the like indicating switching to the target service. At this time, when the connection icon is selected, the current service is switched to the target service, and the display 130 may display content provided by the target service.

The processor 120, according to an exemplary embodiment, may execute one or more programs stored in the memory 140. The processor 120 may include a single core, dual cores, triple cores, quad cores, and cores of multiples thereof. Furthermore, the processor 120 may include a plurality of processors. For example, the processor 120 may be implemented as a main processor and/or a sub processor operating in a sleep mode.

The memory 140, according to an exemplary embodiment, may store various data, programs, or applications for driving and controlling the image display apparatus 100.

The memory 140, according to an exemplary embodiment, may include a channel database for storing found channels and may store information regarding specification of the image display apparatus 100.

Furthermore, the program stored in the memory 140 may also include one or more instructions. A program (e.g., one or more instructions) or an application stored in the memory 140 may be executed by the processor 120.

The processor 120, according to an exemplary embodiment, may control the image display apparatus 100 to receive service linkage information regarding a current service. The processor 120 may read service linkage information related to a certain service provided based on a received broadcast signal from the received broadcast signal. For example, the processor 120 may receive a SLS regarding a service and control the image display apparatus 100 to obtain service linkage information from a USBD fragment included in the SLS.

The processor 120 may determine whether a target service connected to a current service may be provided, based on received service linkage information and the specification of the image display apparatus 100. Service linkage information according to an exemplary embodiment may include at least one of BSID information regarding a target service, identification information regarding target service, information regarding a route for providing the target service, and information regarding a necessary capability of a receiver for reproducing the target service.

Based on availability of the target service, the processor 120 may control the image display apparatus 100 to display an object related to execution of the target service on the display 130. For example, the processor 120 may control the image display apparatus 100 to display an object associated with execution of a target service when the image display apparatus 100 is capable of providing the target service and may control the image display apparatus 100 to not to display an object associated with execution of a target service when the image display apparatus 100 is unable to provide the target service.

The processor 120 may determine whether a target service channel exists in a channel database of the image display apparatus 100, based on BSID information and identification information regarding a corresponding target service. When a target service channel exists in the channel database, the processor 120 may control the image display apparatus 100 to display an object associated with execution of the target service on the display 130. On the contrary, when a target service channel does not exist, the processor 120 may control the image display apparatus 100 to search for the target service channel. Meanwhile, when no target service channel is found, the processor 120 may control the image display apparatus 100 to not to display an object associated with execution of the target service.

Based on the information regarding a route for providing the target service, the processor 120 determines whether the target service is provided via a broadcasting network or an Internet network and, when the target service is provided as an Internet network and the image display apparatus 100 is connected to the Internet network, the processor 120 may control the image display apparatus 100 to display an object associated with execution of the target service on the display 130.

The processor 120 may include a graphics processor for graphics processing in correspondence to the video. The graphics processor may generate a screen image including various objects such as an icon, an image, a text, and the like, and the generated screen image may be displayed on the display 130.

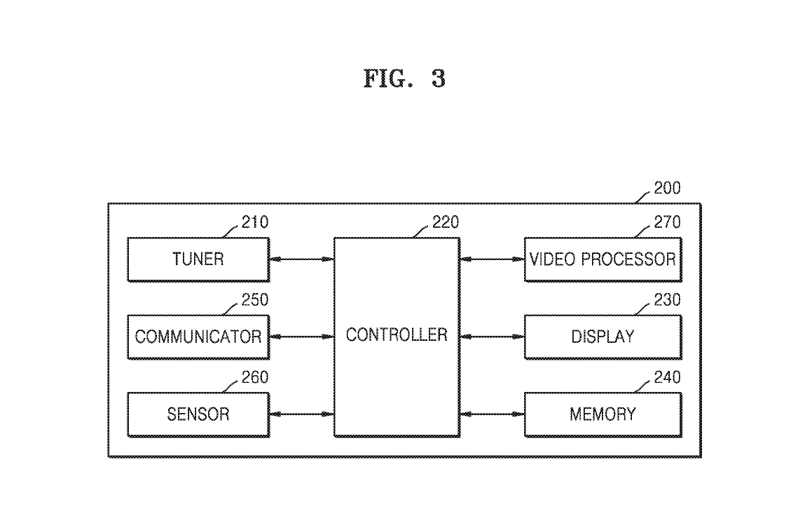

FIG. 3 is a block diagram showing a configuration of an image display apparatus according to another exemplary embodiment. An image display apparatus 200 of FIG. 3, according to an exemplary embodiment, may be a modified version of the image display apparatus 100 of FIG. 1.

Referring to FIG. 3, the image display apparatus 200 may include a tuner 210, a controller 220, a display 230, a memory 240 (e.g., storage unit), a communicator 250, a sensor 260, and a video processor 270.

The processor 120 of FIG. 2 may correspond to the controller 210 of FIG. 3, the memory 140 of FIG. 2 may correspond to the storage unit 240 of FIG. 3, and the display 130 of FIG. 2 may correspond to the display 220 of FIG. 3. Descriptions identical to those given above with reference to FIG. 2 will be omitted below.

The communicator 250 may transmit and receive data and/or signals to and from an external device and/or a server under the control of the controller 210. The controller 210 may transmit and receive content to an external device connected via the communicator 250, download an application from an external device, or perform web browsing. The communicator 250 may transmit and receive data or signals to and from the image display apparatus 200 according to at least one of a wireless local area network (LAN) (e.g., Wi-Fi), Bluetooth, and wired Ethernet in correspondence to the performance and structure of the image display apparatus 200. The communicator 250 may download content of a target service when a route for providing the target service is an Internet network.

The tuner 240 may receive a broadcast signal received via a wire or wirelessly and tune and select only the frequency of a channel to be received by the image display apparatus 100 from among many radio wave components through amplification, mixing, resonance, or the like. A broadcast signal includes audio, video, and additional information (e.g., electronic service guide (ESG), electronic program guide (EPG), etc.).

The tuner 240 may receive a broadcast signal in a frequency band corresponding to a channel number based on a user input (e.g., a control signal received from a control device 300 including a channel number input, a channel up/down input, and/or a channel input in an EPG screen image).

The tuner 240 may receive broadcast signals from various sources such as ground wave broadcasts, cable broadcasts, satellite broadcasts, Internet broadcasts, and the like. The tuner 240 may receive a broadcast signal from a source such as an analog broadcast or a digital broadcast.

A video processor 270 processes video data received by the image display apparatus 200. The video processor 270 may perform various image processing, such as decoding, scaling, noise filtering, frame rate conversion, resolution conversion, and the like, on the video data.

The sensor 260 senses a user's voice, a user's image, and/or a user's interaction. The sensor 260 according to an exemplary embodiment may sense a user input for selecting an icon indicating a switch to a target service.

The controller 220 controls the overall operation of the image display apparatus 200 and signal flows between internal components of the image display apparatus 200 and performs data processing function. The controller 220 may execute an operating system (OS) and various applications stored in the storage unit 240 when the user applies an input or pre-set conditions are satisfied.

The storage unit 240 may store various data, programs, or applications for driving and controlling the image display apparatus 200 under the control of the controller 210. The storage unit 240 according to an exemplary embodiment may include a channel database for storing found channels and may store specification information regarding the image display apparatus 200.

The image display apparatuses 100 and 200 shown in FIGS. 2 and 3 are merely examples. Components of the image display apparatuses 100 and 200 may be integrated, added, or omitted according to specifications of the actually implemented image display apparatuses 100 and 200. In other words, as occasions demand, two or more components may be combined into one component or one component may be divided into two or more components. Furthermore, functions performed by respective blocks are merely intended to describe exemplary embodiments, and are not limited to a specific operation or a specific apparatus.

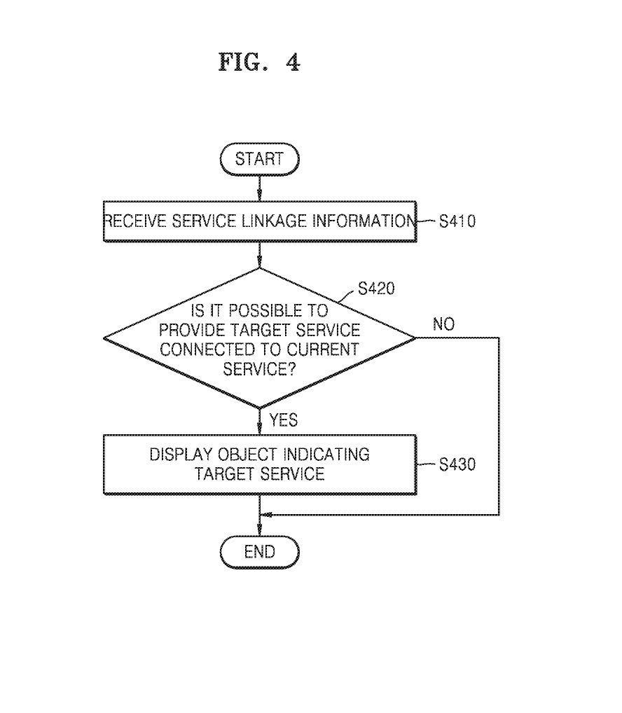

FIG. 4 is a flowchart of a method by which an image display apparatus provides a target service, according to an exemplary embodiment.

Referring to FIG. 4, in operation S410, the image display apparatus 100 according to an exemplary embodiment may receive service linkage information.

For example, the image display apparatus 100 may receive a broadcast signal and read service linkage information related to a certain service provided based on the broadcast signal from the received broadcast signal.

The image display apparatus 100 may receive service linkage information via a broadcasting network or a broadband (e.g., Internet network). The image display apparatus 100 according to an exemplary embodiment may receive a SLS and obtain service linkage information from the SLS. For example, the image display apparatus 100 may acquire service linkage information based on a service linkage element in a USBD (User Service Bundle Description) fragment included in the SLS. However, exemplary embodiments are not limited thereto.

In operation S420, the image display apparatus 100 may determine whether the image display apparatus may provide a target service connected to a current service, based on the service linkage information and the specification of the image display apparatus 100.

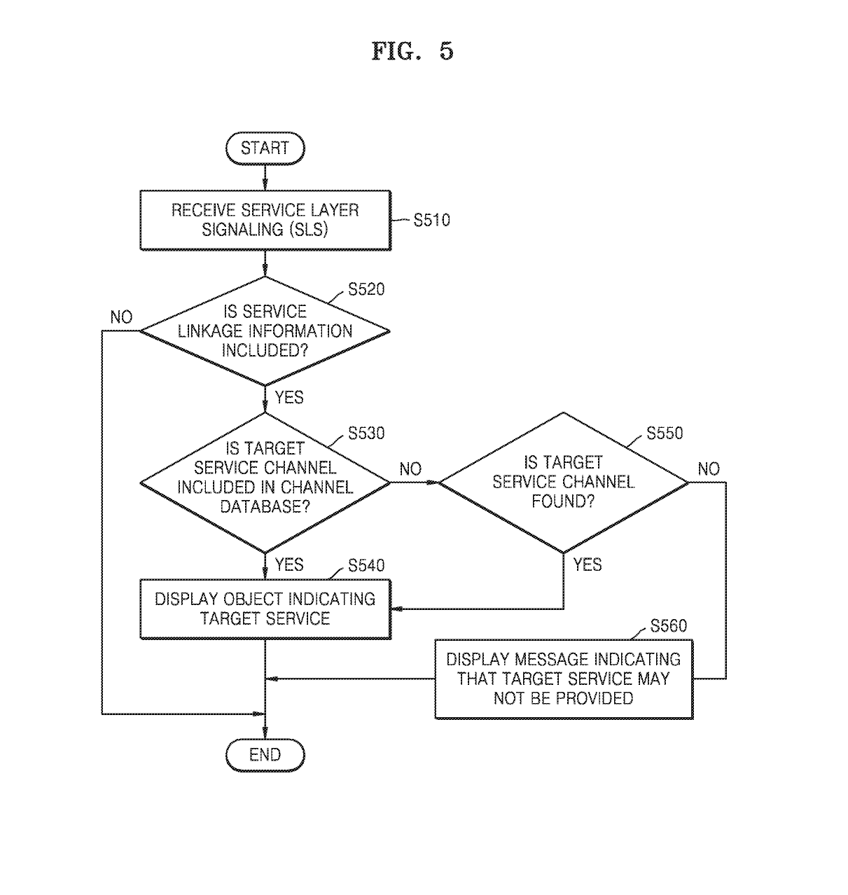

For example, the image display apparatus 100 may determine whether a target service may be provided based on information regarding a channel providing the target service, information regarding a route for providing the target service, and information regarding necessary capability of a receiver for reproducing the content included in the target service. Detailed description thereof will be given below with reference to the flowcharts shown in FIGS. 5 through 7.

If the image display apparatus 100 may provide a target service, the image display apparatus 100 may display an object indicating the target service in operation S430. The object indicating the target service may include an object related to execution of the target service. For example, an icon indicating a switch to the target service may be displayed or a message indicating that the target service exists may be displayed.

FIG. 5 is a flowchart of a method by which an image display apparatus provides a target service, according to an exemplary embodiment.

Referring to FIG. 5, the image display apparatus 100, according to an exemplary embodiment, may receive a SLS in operation S510.

A SLS may provide specific and descriptive information that enables a ground wave ultra high-definition television (UHDTV) broadcast receiver to discover and obtain ground wave UHDTV broadcast services and components. A SLS is given for each service and includes characteristics of a corresponding service, e.g., a list of components constituting the corresponding service, information necessary for obtaining each component, and information regarding necessary capability of a receiver for reproducing the service. The SLS according to an exemplary embodiment may include connected service information indicating connectivity between services.

The image display apparatus 100 according to an exemplary embodiment may check whether service linkage information is included in the SLS in operation S520.

For example, the service linkage information may be included as a service linkage element in a USBD fragment included in a SLS. The service linkage information includes information regarding a target service associated with a corresponding service, information regarding a time period during which the target service is available, information regarding a link type, information regarding a route for providing the target service, and information regarding a necessary capability of a receiver for reproducing the target service.

In operation S530, the image display apparatus 100 according to an exemplary embodiment may determine whether a channel corresponding to the target service is included in a channel database of the image display apparatus, based on BSID information and target service ID information of the target service included in the target service information.

When a channel corresponding to the target service is included in the channel database of the image display apparatus 100, the image display apparatus 100 may display an object indicating the target service in operation S540.

An object indicating a target service may include an object related to execution of the target service. For example, an icon indicating a switch to the target service may be displayed or a message indicating that the target service exists may be displayed.

On the contrary, when a channel corresponding to the target service is not included in the channel database of the image display apparatus 100, the image display apparatus 100 may search for a channel corresponding to the target service in operation S550. When a channel corresponding to the target service is found, the corresponding channel may be stored in the channel database and an object indicating the target service may be displayed in the operation S540.

If a channel corresponding to the target service is not found, the image display apparatus 100 may not display an object indicating the target service and display a message indicating that the target service may not be provided in operation S560.

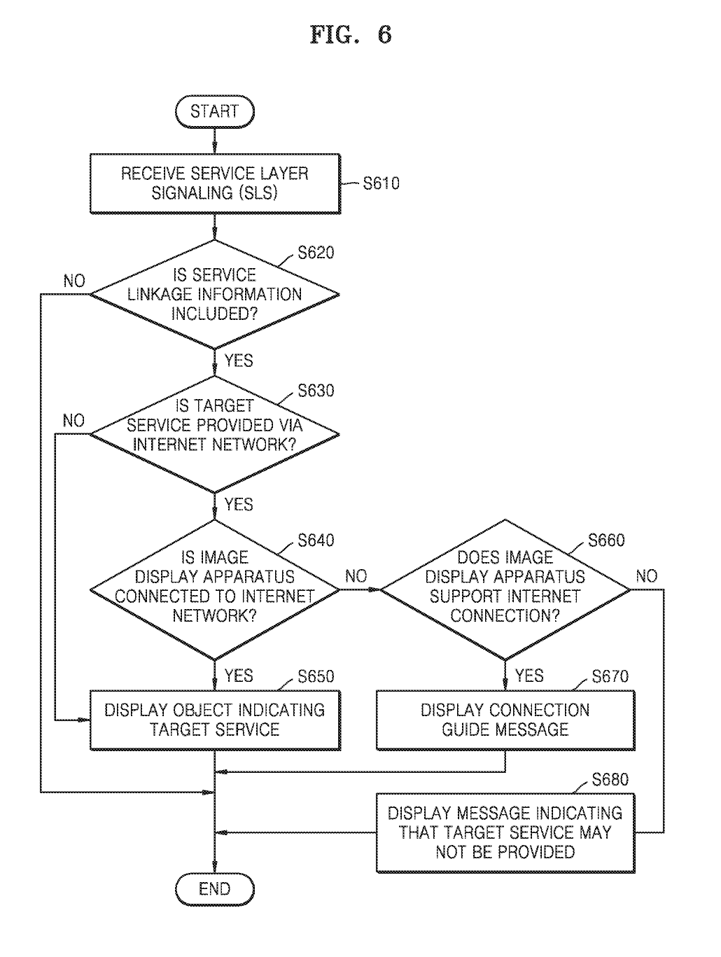

FIG. 6 is a flowchart of a method by which an image display apparatus 100 provides a target service, according to an exemplary embodiment.

Referring to FIG. 6, the image display apparatus 100 according to an exemplary embodiment may receive SLS in operation S610 and check whether service linkage information is included in the SLS in operation S620. Because the operations S610 and S620 respectively correspond to the operations S510 and S520 of FIG. 5, detailed descriptions thereof will be omitted.

When the SLS includes service linkage information, the image display apparatus 100 according to an exemplary embodiment may determine whether the target service is transmitted via a broadcasting network or an Internet network in operation S630. At this time, information regarding a route for providing the target service may be defined in the broadcastAccessRequired element from among elements included in the service linkage information. However, exemplary embodiments are not limited thereto.

When the target service is transmitted via a broadcasting network, the image display apparatus 100 may display an object indicating the target service in operation S650.

On the other hand, when the target service is provided via an Internet network, the image display apparatus 100 may determine whether the image display apparatus 100 is currently connected to the Internet in operation S640. When it is determined that the target display apparatus 100 is connected to the Internet, the image display apparatus 100 may display an object indicating the target service in operation S650.

If it is determined that the image display apparatus 100 is not connected to the Internet, then it is determined whether the image display apparatus supports internet connection in operation S660. If it is determined that the image display apparatus 100 is not connected to the Internet and the image display apparatus 100 supports Internet connection, the image display apparatus 100 may display a guide message instructing to connect the image display apparatus 100 to the Internet in operation S670.

Alternatively, when the image display apparatus 100 does not support Internet connection, the image display apparatus 100 may display a message indicating that the connected service may not be provided in operation S680.

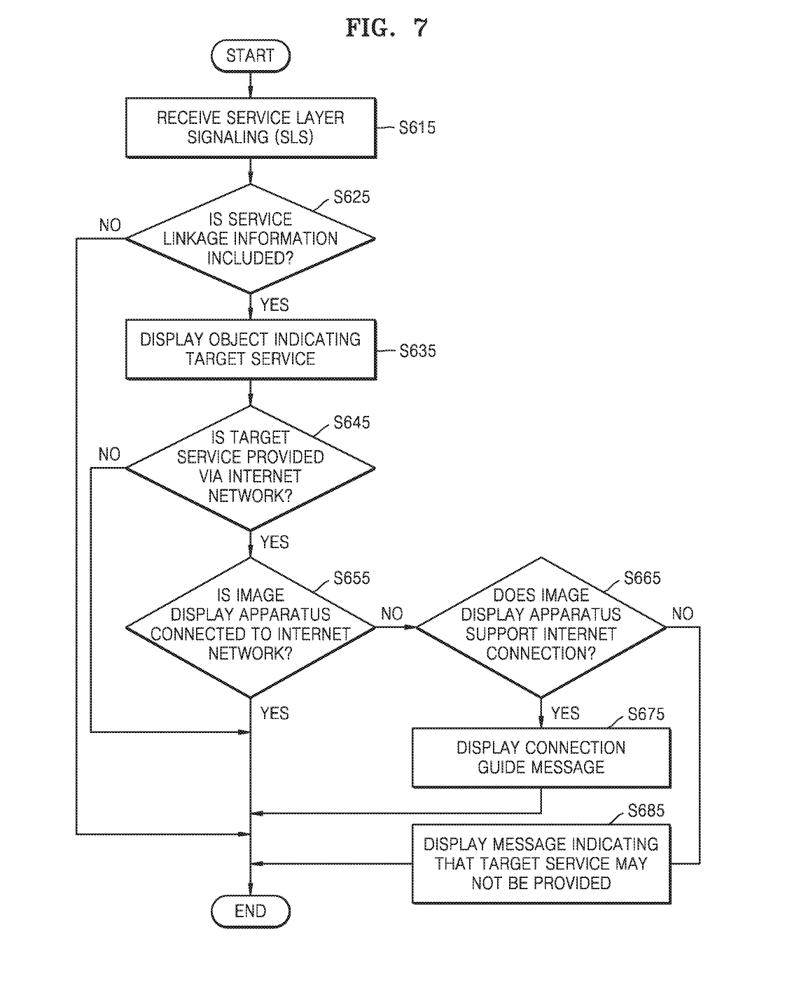

FIG. 7 is a flowchart of a method by which an image display apparatus provides a target service, according to an exemplary embodiment.

Referring to FIG. 7, the image display apparatus 100 according to an exemplary embodiment may receive a SLS in operation S615 and may check whether service linkage information is included in the SLS in operation S625. The operations S615 and S625 respectively correspond to the operations S510 and S520 of FIG. 5, and thus detailed descriptions thereof will be omitted.

If the service linkage information is included in the image display apparatus 100, the image display apparatus 100 may display an object indicating the target service in operation S635.

In operation S645, the image display apparatus 100 according to an exemplary embodiment may determine whether a target service is transmitted via a broadcasting network or an Internet network, based on information regarding a route for providing the target service included in service linkage information. At this time, the information regarding a route for providing the target service may be described in the broadcastAccessRequired element from among elements included in the service linkage information. However, exemplary embodiments are not limited thereto.

When the target service is transmitted through a broadcasting network, the image display apparatus 100 may check whether the image display apparatus 100 is currently connected to the Internet in operation S655. When the image display apparatus 100 is not connected to the Internet, the image display apparatus 100 may check whether the image display apparatus 100 supports Internet connection in operation S665.

When the image display apparatus 100 supports Internet connection, a guide message instructing to connect to the Internet may be displayed in operation S675. On the contrary, when the image display apparatus does not support Internet connection, the image display apparatus 100 may display a message indicating that the connected service may not be provided in operation S685.

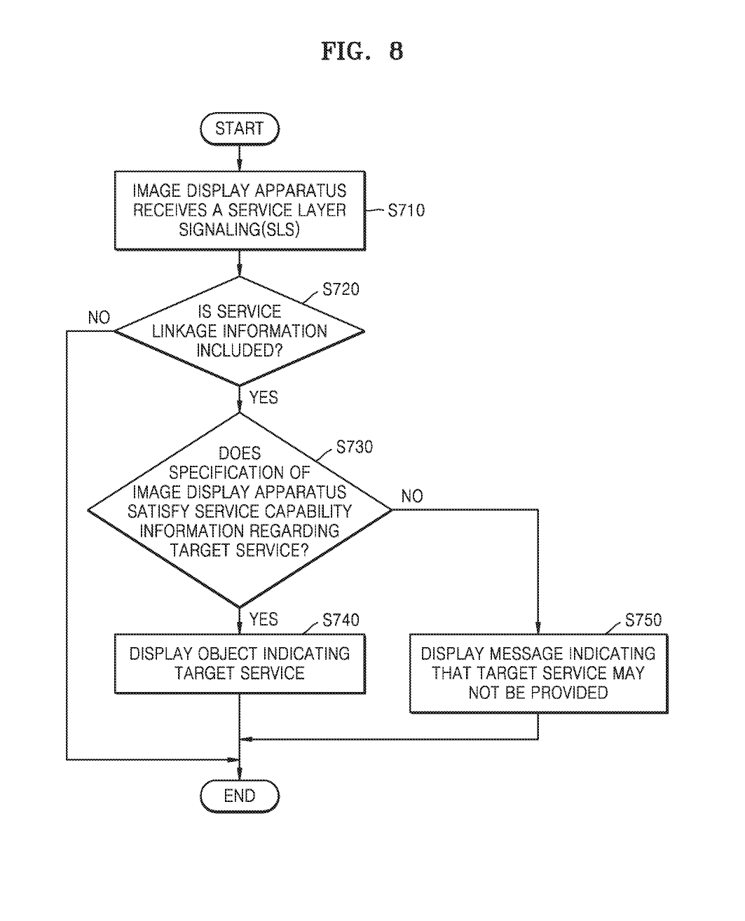

FIG. 8 is a flowchart of a method by which an image display apparatus provides a target service, according to an exemplary embodiment.

Referring to FIG. 8, the image display apparatus 100 according to an exemplary embodiment may receive a SLS in operation S710 and may check whether service linkage information is included in the SLS in operation S720. The operations 710 and 720 respectively correspond to the operations S510 and S520 of FIG. 5, and thus detailed descriptions thereof will be omitted.

When service linkage information is included, the image display apparatus 100 according to an exemplary embodiment may compare information regarding a necessary capability of a receiver for reproducing the target service (e.g., service capability information) included in the service linkage information to the specifications of the image display apparatus 100 in operation S730. At this time, the service capability information included in the service linkage information may be described in the svcCapabilities element from among elements included in the service linkage information. However, exemplary embodiments are not limited thereto.

Furthermore, the service capability information may include a capability demanded to decode and effectively express content of the target service. For example, the service capability information may include information regarding the resolution of content of the target service, codec information regarding the content of the target service, protocol information for downloading the content of the target service, and Internet speed information for downloading the content of the target service. However, exemplary embodiments are not limited thereto.

When the specification of the image display apparatus satisfies capabilities for decoding and effectively expressing content of the target service, the image display apparatus 100 according to an exemplary embodiment may display an object indicating the target service in operation S740.

On the contrary, when the specification of the image display apparatus 100 does not satisfy capabilities for decoding and effectively expressing content of the target service, the image display apparatus 100 may not display an object indicating the target service. Alternatively, the image display apparatus 100 may display a message indicating that the connected service may not be provided in operation S750. For example, when the resolution of content of the target service is 8K ultra high definition (UHD) and the output resolution of the image display apparatus is 4K UHD, the image display apparatus 100 may not display the object indicating the target service.

Meanwhile, although it is described above with reference to FIGS. 5 through 9 that it is determined whether to display an object indicating a target service based on whether a channel corresponding to the target service is stored in the image display apparatus 100 or is found, whether the image display apparatus 100 is connected to the Internet when the target service is provided via the Internet, and whether the specification of the image display apparatus 100 satisfies a necessary capability of a receiver for reproducing content of the target service, exemplary embodiments are not limited. For example, according to an exemplary embodiment, an icon indicating a target service may be displayed only when a channel corresponding to the target service is stored or found, the target service is provided via a broadcast network, the image display apparatus 100 is connected to an Internet network even when the target service is provided via the Internet network, and the specification of the image display apparatus 100 satisfies a necessary capability of a receiver for reproducing content of the target service.

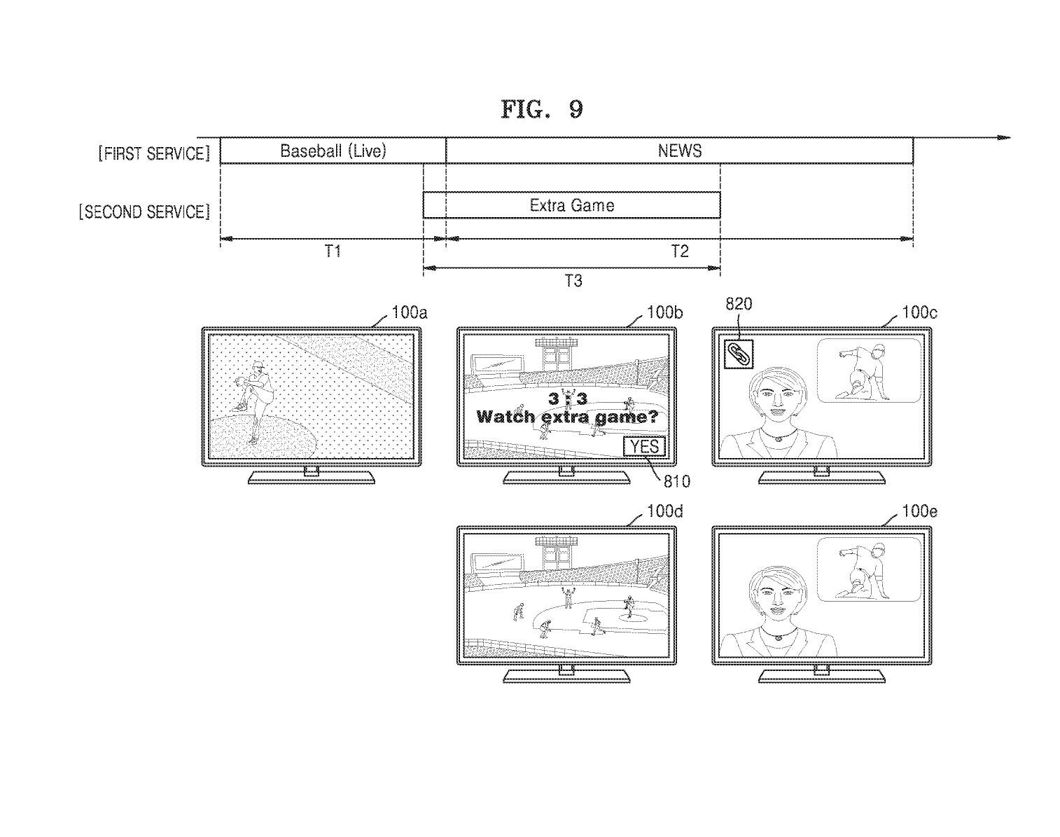

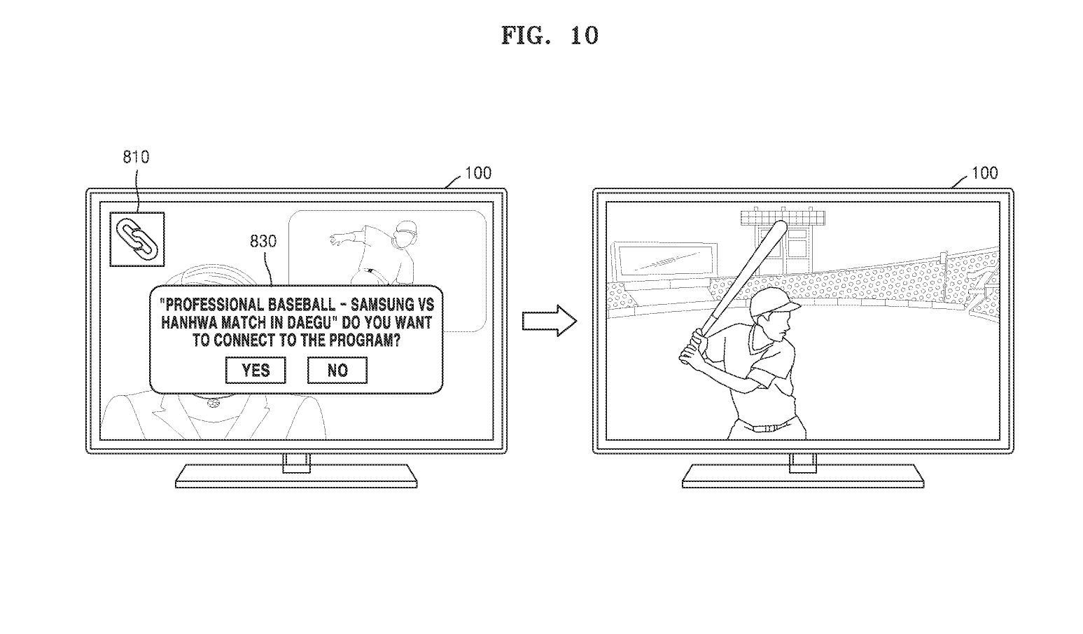

FIGS. 9 and 10 are diagrams for describing a method by which an image display apparatus provides a target service, according to an exemplary embodiment.

Referring to FIG. 9, the image display apparatus 100 according to an exemplary embodiment may receive a broadcast signal corresponding to a first service and display broadcast images generated based on the received broadcast signal on a display. For example, when the first service provides a baseball broadcast during a first time period T1, the image display apparatus 100 may display images corresponding to the baseball broadcast (e.g., display apparatus 100a at left side of FIG. 9). Furthermore, when a news broadcast is provided during a second time period T2 in the first service, the image display apparatus 100 may display images corresponding to the news broadcast.

Meanwhile, a second service may be a service (e.g., target service) connected to the first service in order to provide a baseball broadcast after the first time period T1.

The image display apparatus 100 may receive service linkage information regarding the first service. At this time, the service linkage information regarding the first service may include information regarding the second service (e.g., BSID information regarding the second service, identification information regarding the second service, etc.), information regarding a time period during which the second service is available, information regarding a route for providing the second service, information regarding a necessary capability of a receiver for reproducing the second service, etc.

The image display apparatus 100 may determine whether the image display apparatus 100 may provide the second service based on the information regarding the second service and the specification of the image display apparatus 100. Since the detailed descriptions thereof are given above with reference to FIGS. 5 through 8, detailed descriptions thereof will be omitted below.

When the second service is a service that may be provided by the image display apparatus 100, the image display apparatus 100 may display an UI screen image including an object 810 for switching from the first service to the second service during the last portion of a baseball broadcast in the first service in a third time period T3 during which the second service is available (e.g., display apparatus 100b at center of FIG. 9). Furthermore, in the third time period T3 during which the second service is available, while a news broadcast is being provided after the baseball broadcast is terminated in the first service, the image display apparatus 100 may display a connection icon 820 in images of the news broadcast (e.g., display apparatus 100c at right side of FIG. 9), furthermore, when the baseball broadcast is terminated in the second service (after the third time period T3),

On the other hand, when the second service is a service that may not be provided by the image display apparatus 100, the image display apparatus 100 may not display a UI screen including an object for switching to the second service (e.g., display apparatus 100d at center of FIG. 9) and may also not display a connection icon indicating a connected service (e.g., display apparatus 100e at right side of FIG. 9). For example, when a channel that provides the second service is not stored in the image display apparatus 100 and is not found, when the second service is provided via an Internet network and the image display apparatus 100 may not be connected to the Internet, or when the image display apparatus 100 is unable to decode and effectively express content of the second service, the image display apparatus 100 may not display an object indicating a switch to the target service.

Therefore, even when a target service may not be provided, an object related to execution of the target service is provided, thereby preventing a user from being confused.

Referring to FIG. 10, while the connection icon 810 is being displayed, the image display apparatus 100 may receive an input for selecting the connection icon 810. In response to the input for selecting the connection icon 810, the image display apparatus 100 may display a first message 830 asking whether to switch the current service to the target service, as shown in FIG. 10. Here, the first message 830 may include information regarding content provided by the first service at a time point from which the target service becomes available.

When the image display apparatus 100 receives an input for selecting a first object (“YES”) included in the first message 830, the image display apparatus 100 may display content provided by the first target service. For example, as shown in FIG. 10, when an extra baseball game broadcast is being provided in the target service, the image display apparatus 100 may receive a broadcast signal corresponding to the target service and provide the extra baseball game broadcast.

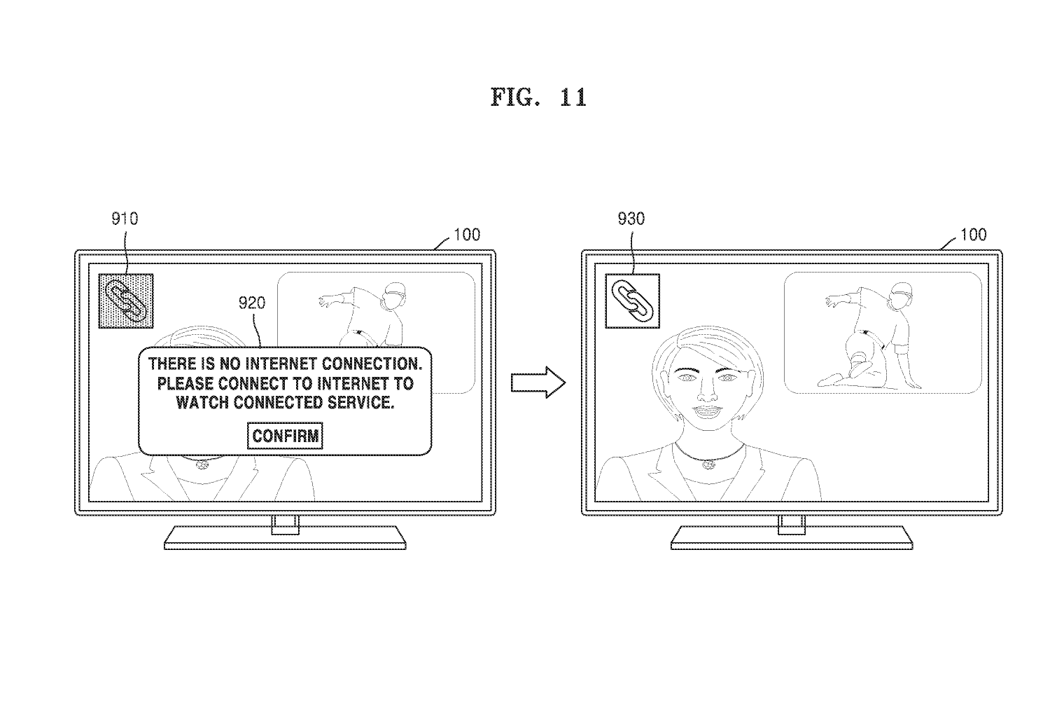

FIG. 11 is a diagram illustrating a method by which an image display apparatus displays a guide message for service connection, according to an exemplary embodiment.

Referring to FIG. 11, the image display apparatus 100 may determine whether the image display apparatus 100 may provide a second service based on received service linkage information and the specification of the image display apparatus 100. Here, when the image display apparatus 100 may not provide the second service, the image display apparatus 100 may display an inactivated connection icon 910 and a guide message 920 as shown in FIG. 11.

For example, when the second service is provided via an Internet network and the image display apparatus 100 is not currently connected to the Internet network, the image display apparatus 100 may display the guide message 920 indicating that the image display apparatus 100 is not currently connected to the Internet and instructing to connect the image display apparatus 100 to the Internet.

Furthermore, when the image display apparatus 100 is connected to the Internet according to the guide message 920, the image display apparatus 100 may display an activated connection icon 930 as shown in FIG. 11. When the activated connection icon 930 is displayed, a user may select the activated connection icon 930, thereby switching the first service to the second service.

An image display apparatus according to an exemplary embodiment displays an object related to execution of a target service only when the target service may be provided and does not display an object related to execution of the target service when the target service may not be provided. Therefore, user confusion may be prevented.

Because unnecessary information regarding service connection is not provided, user convenience may be improved.

The above-described exemplary embodiments may be implemented as programmable instructions executable by a variety of computer components and stored in a computer readable recording medium. The computer readable recording medium may include program instructions, a data file, a data structure, or any combination thereof. The program instructions stored in the computer readable recording medium may be designed and configured for the exemplary embodiments or can be publicly known and available to those skilled in the field of software. Examples of the computer readable recording medium include a hardware device specially configured to store and perform program instructions, for example, a magnetic medium, such as a hard disk, a floppy disk, and a magnetic tape, an optical recording medium, such as a CD-ROM, a DVD, and the like, a magneto-optical medium, such as a floptical disc, a ROM, a RAM, a flash memory, and the like. Examples of the program instructions include machine codes made by, for example, a compiler, as well as high-level language codes executable by a computer using an interpreter.

It should be understood that exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims.

What is claimed is:

1. An image display apparatus comprising:
a display;
a receiver configured to receive a broadcast signal;
a processor; and
a memory configured to store instructions that, when executed by the processor, cause the processor to:
provide a service based on the received broadcast signal;
process service linkage information related to the service based on the received broadcast signal;
determine whether to provide a target service connected to the service based on specification information of the image display apparatus and the service linkage information; and
display an object related to an execution of the target service on the display based on an availability of the target service.

2. The image display apparatus of claim 1, wherein the service linkage information comprises at least one from among broadcast service identifier (BSID) information regarding the target service, identification information regarding the target service, information regarding a route for providing the target service, and information regarding a capability of a receiver for providing the target service.

3. The image display apparatus of claim 2, wherein the instructions cause the processor to determine whether a channel corresponding to the target service exists in a channel database of the image display apparatus based on the BSID information regarding the target service and the identification information regarding the target service and, in response to determining that a channel corresponding to the target service exists in the channel database, display an object related to the execution of the target service on the display.

4. The image display apparatus of claim 3, wherein the instructions cause the processor to, in response to determining that a channel corresponding to the target service does not exist in the channel database, search for a channel corresponding to the target service.

5. The image display apparatus of claim 4, wherein the instructions cause the processor to, in response to determining that a channel corresponding to the target service is not found, not display an object related to the execution of the target service.

6. The image display apparatus of claim 2, wherein the instructions cause the processor to determine whether the target service is to be provided via a broadcast network or an Internet network based on the information regarding the route for providing the target service and, in response to determining that the target service is to be provided via the Internet network and the image display apparatus is connected to the Internet network, display an object related to the execution of the target service.

7. The image display apparatus of claim 2, wherein the instructions cause the processor to determine whether the target service is to be provided via a broadcast network or an Internet network based on the information regarding the route for providing the target service and, in response to determining that the target service is to be provided via the Internet network and the image display apparatus is not connected to the Internet network, display a guide message instructing to connect the image display apparatus to the Internet network.

8. The image display apparatus of claim 2, wherein the instructions cause the processor to, in response to determining that the specification of the image display apparatus satisfies the capability of the receiver for reproducing content of the target service, display an object related to the execution of the target service.

9. The image display apparatus of claim 2, wherein the instructions cause the processor to, in response to determining that the specification of the image display apparatus does not satisfy the capability of the receiver for reproducing content of the target service, not display an object related to the execution of the target service.

10. The image display apparatus of claim 1, wherein an object indicating the target service comprises a connection icon indicating a switch to the target service, and
wherein the instructions cause the processor to, in response to determining that an input for selecting the connection icon is received, switch a current service to the target service.

11. The image display apparatus of claim 1, wherein the instructions cause the processor to receive a service layer signaling (SLS) regarding a current service and obtain the service linkage information from the SLS.

12. The image display apparatus of claim 11, wherein the instructions cause the processor to obtain the service linkage information from a user service bundle description (USBD) fragment included in the SLS.

13. A method of operating an image display apparatus, the method comprising:
receiving a broadcast signal;
processing service linkage information related to a service provided based on the received broadcast signal;
determining whether to provide a target service connected to the service based on specification information of the image display apparatus and the service linkage information; and
displaying an object related to an execution of the target service based on an availability of the target service.

14. The method of claim 13, wherein the service linkage information comprises at least one from among broadcast service identifier (BSID) information regarding the target service, identification information regarding the target service, information regarding a route for providing the target service, and information regarding a capability of a receiver for providing the target service.

15. The method of claim 14, wherein the determining whether to provide the target service comprises determining whether a channel corresponding to the target service exists in a channel database of the image display apparatus based on the BSID information regarding the target service and the identification information regarding the target service, and
wherein the displaying the object related to the execution of the target service comprises, in response to determining that a channel corresponding to the target service exists in the channel database, displaying an object related to the execution of the target service.

16. The method of claim 15, further comprising searching for a channel corresponding to the target service in response to determining that a channel corresponding to the target service does not exist in the channel database,
wherein the displaying of the object related to the execution of the target service comprises, in response to determining that a channel corresponding to the target service is found, displaying an object related to the execution of the target service.

17. The method of claim 14, wherein the determining whether to provide the target service comprises determining whether the target service is to be provided via a broadcast network or an Internet network based on the information regarding the route for providing the target service, and
wherein the displaying the object related to the execution of the target service comprises, in response to determining that the target service is to be provided via the Internet network and the image display apparatus is connected to the Internet network, displaying an object related to the execution of the target service.

18. The method of claim 14, wherein the determining whether to provide the target service comprises determining whether the target service is to be provided via a broadcast network or an Internet network based on the information regarding the route for providing the target service, and
wherein the displaying the object related to the execution of the target service comprises, in response to determining that the target service is to be provided via the Internet network and the image display apparatus is not connected to the Internet network, displaying a guide message instructing to connect the image display apparatus to the Internet network.

19. The method of claim 14, wherein the determining whether to provide the target service comprises determining whether the specification of the image display apparatus satisfies the capability of the receiver for reproducing content of the target service, and
wherein the displaying of the object related to execution of the target service comprises displaying an object related to execution of the target service in response to determining that the specification of the image display apparatus satisfies the capability of the receiver for reproducing content of the target service.

20. A non-transitory computer readable recording medium having recorded thereon a computer program that is executed by a computer for performing the method of claim 13.
